(19) United States
(12) Patent Application Publication
(10) Pub. No.: US 2021/0023786 A1
(43) Pub. Date: Jan. 28, 2021

(54) Three-Dimensional Printing System with Improved Optical Path

(71) Applicant: 3D Systems, Inc., Rock Hill, SC (US)

(72) Inventor: Hai Quang Tran, San Diego, CA (US)

(21) Appl. No.: 16/938,665

(22) Filed: Jul. 24, 2020

Related U.S. Application Data
(60) Provisional application No. 62/878,463, filed on Jul. 25, 2019.

(51) Int. Cl. B29C 64/255; B33Y 30/00; B29C 64/245; B29C 64/264; B29C 64/124

(52) U.S. Cl. CPC B29C 64/255; B33Y 30/00; B29K 2823/38; B29C 64/264; B29C 64/124; B29C 64/245

(57) ABSTRACT

A three-dimensional printing system includes a resin vessel, a light engine, a build tray, motorized support, and a controller. The resin vessel includes a vessel body defining a central opening and a transparent sheet that closes the central opening. The transparent sheet is at least partially formed from a cyclic olefin polymer (COP) that is synthesized in part by applying a ring-opening metathesis polymerization (ROMP) to a monomer. The light engine is configured to project pixelated light through the transparent sheet and to a build plane within the resin. The build tray defines a support surface for supporting the three-dimensional article to be at least partially submerged in the resin. The motorized support is configured to align and adjust a vertical position of the build tray. The controller is for controlling the light engine and the motorized support for fabricating the three-dimensional article.

### CROSS-REFERENCE TO RELATED APPLICATIONS

This non-provisional patent application claims priority to U.S. Provisional Application Ser. No. 62/878,463, Entitled “Three-Dimensional Printing System with Improved Optical Path” by Hai Quang Tran, filed on Jul. 25, 2019, incorporated herein by reference under the benefit of U.S.C. 119(e).

### FIELD OF THE INVENTION

The present disclosure concerns an apparatus for fabrication of solid three-dimensional articles from radiation curable (photocurable) resins in a layer-by-layer manner. More particularly, the present disclosure concerns an advantageous material solution for an optical path for such an apparatus.

### BACKGROUND

Three dimensional (3D) printers are in rapidly increasing use. One class of 3D printers includes stereolithography printers having a general principle of operation including the selective curing and hardening of radiation curable (photocurable) liquid resins. A typical stereolithography system includes a resin vessel holding the photocurable resin, a movement mechanism coupled to a support tray, and a controllable light engine. The stereolithography system forms a three dimensional (3D) article of manufacture by selectively curing layers of the photocurable resin onto a surface of the support tray. Each selectively cured layer is formed at a “build plane” within the resin.

One variant of this type of system defines a build plane between a lower face of the support tray and a flexible, transparent sheet. One challenge with such a system is to find materials for the transparent sheet. Nearly all potential polymers for such a transparent sheet fail in some way. Some are damaged quickly by the resin. Others are “fouled” by a hardening of resin upon the transparent sheet. Yet others don't have a necessary optical clarity for ultraviolet light that enables for the formation of precision articles of manufacture.

### BRIEF DESCRIPTION OF THE FIGURES

FIG. 1 is a schematic diagram of an embodiment of a three-dimensional printing system 2.

FIG. 2 is an isometric cutaway view of a portion of an embodiment of a resin vessel.

FIG. 3 is an isometric cutaway view of a portion of a resin vessel supported by a support plate.

FIG. 4A is a first embodiment of a portion of a transparent sheet.

FIG. 4B is a second embodiment of a portion of a transparent sheet.

FIG. 4C is a third embodiment of a portion of a transparent sheet.

### SUMMARY

In an aspect of the disclosure, a three-dimensional printing system includes a resin vessel, a light engine, a build tray, motorized support, and a controller. The resin vessel includes a vessel body defining a central opening and a transparent sheet that closes the central opening. The transparent sheet is at least partially formed from a cyclic olefin polymer (COP) that is synthesized in part by applying a ring-opening metathesis polymerization (ROMP) to a monomer. The light engine is configured to project pixelated light through the transparent sheet and to a build plane within the resin. The build tray defines a support surface for supporting the three-dimensional article to be at least partially submerged in the resin. The motorized support is configured to align and adjust a vertical position of the build tray. The controller is for controlling the light engine and the motorized support for fabricating the three-dimensional article.

In one implementation, the transparent sheet is a single layer of COP. In some embodiments a thickness can vary from about 25 microns (1000 microns equals a millimeter) to about 200 microns. More particularly, a thickness can vary from about 50 microns to about 150 microns. Yet more particularly, thicknesses of about 50 microns, 100 microns, 150 microns, or 188 microns may be suitable for certain systems.

In another implementation, the transparent sheet is a multilayer film including at least one layer of COP and at least one layer that is not COP. The layer that is not COP can be silicone and/or Teflon AF2400. The layers can include a thick layer of silicone with one or two layers of COP. The layers can include a layer of COP with one or two layers of Teflon AF2400.

In yet another implementation, the monomer is norbornene. In forming the COP, the norbornene is first subjected to ROMP and is then subjected to a hydrogenation.

In a further implementation, a rigid transparent plate supports the transparent sheet. The rigid transparent plate can be formed from glass. In other embodiments, the transparent plate can be formed form injection molded COP.

### DETAILED DESCRIPTION OF THE PREFERRED EMBODIMENTS

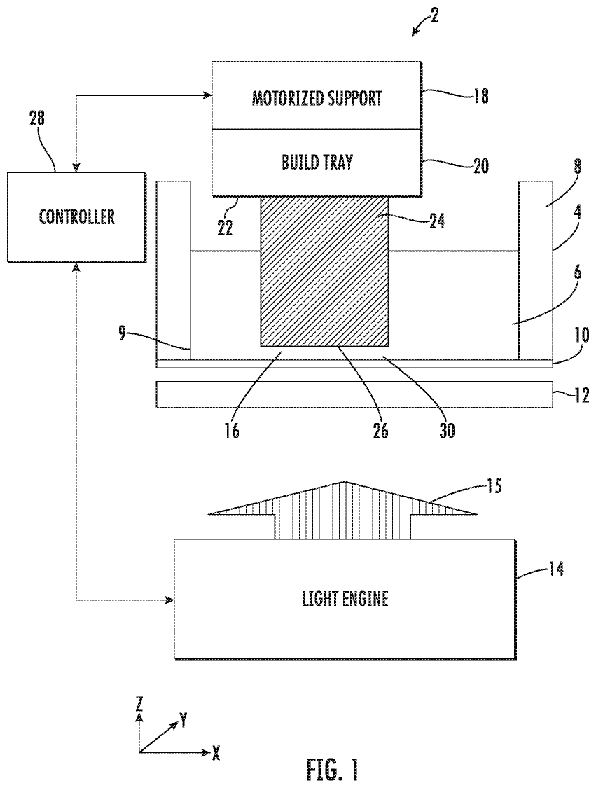

FIG. 1 is a schematic diagram of an embodiment of a three-dimensional printing system 2. In describing system 2, axes X, Y, and Z can be used. Axes X and Y are generally horizontal and axis Z is generally vertical and generally aligned with a gravitational reference. As discussed herein, the term “generally” refers to having a dimension, an angle, or other parameter that is within manufacturing or placement tolerances.

Printing system 2 includes a resin vessel 4 for containing resin 6. Resin vessel 4 includes a vessel body 8 that defines a central opening 9. The central opening 9 is closed by a transparent sheet 10.

The transparent sheet 10 is formed from an optically clear material that has a permeability to a reaction inhibitor such as oxygen (from ambient air or from another oxygen source). The transparent sheet is at least partially formed from a cyclic olefin polymer (COP) that is synthesized in part by applying a ring-opening metathesis polymerization (ROMP) to a monomer. In an embodiment, the monomer is norbornene. In a further embodiment, the monomer is first subjected to ROMP and then it is subjected to a hydrogenation during material formation.

The resin vessel 4 is supported by a support plate 12. The support plate 12 includes a central transparent opening and/or plate (to be shown in subsequent figures) that is laterally aligned with the transparent sheet 10. A light engine 14 is configured to project pixelated light 15 up through the support plate 12, through the transparent sheet 10, and to a build plane 16 within the resin 6. The build plane 16 is a lateral region of the resin 6 that can be imaged by the light engine 14.

A motorized support 18 is configured to vertically position a build tray 20. Build tray 20 has a lower surface 22 for supporting a three-dimensional article 24 being fabricated by system 2. The three-dimensional article 24 has a lower face 26 that is in facing relation with the transparent sheet 10 and is proximate to the build plane 16.

A controller 28 is coupled to the light engine 14 and the motorized support 18. Controller 28 includes a processor coupled to an information storage device. The information storage device includes a nonvolatile or non-transient storage device storing software instructions. When the software instructions are executed by the processor, they operate the light engine 14 and motorized support and perform the following steps: (1) Operate the motorized support 18 to position surface 22 (or afterwards surface 26) at build plane 16. (2) Operate light engine 14 to selectively solidify a layer of resin onto surface 22 or 26. (3) Repeat (1) and (2) to complete fabrication of the three-dimensional article 24.

As material is being solidified onto surface 22 or 26, there is a inhibited zone 30 of resin immediately adjacent the transparent sheet 10 that does not polymerize. That is because an inhibitor such as oxygen diffuses through the transparent sheet 10 and the inhibited zone 30.

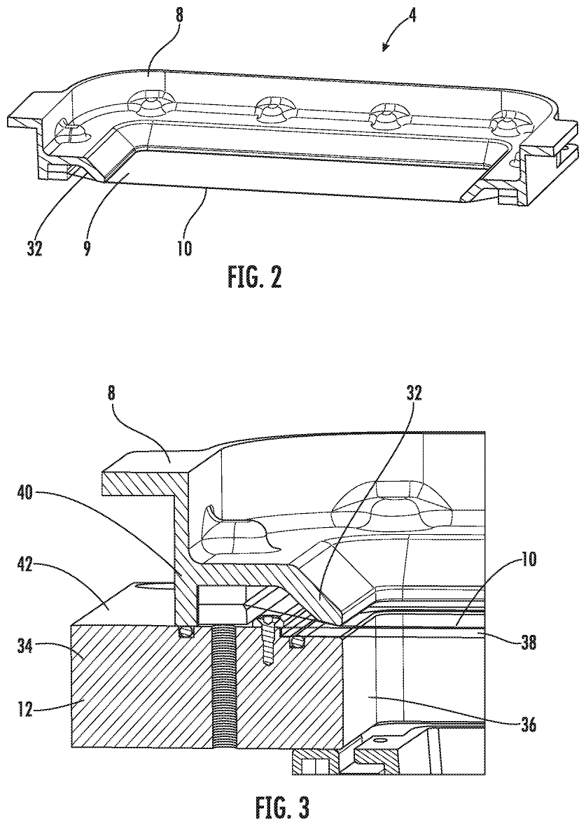

FIG. 2 is an isometric cutaway view of a portion of an embodiment of a resin vessel 4. Resin vessel 4 includes vessel body 8 that defines central opening 9 which is closed by the transparent sheet 10. Vessel body 8 also includes a tension ring 32 that tensions the transparent sheet 10. The tensioning improves planarity of the transparent sheet 10.

FIG. 3 is an isometric cutaway view of a portion of the resin vessel supported by the support plate 12. The support plate 12 includes a plate body 34 that defines an central opening 36. The central opening 36 is closed by a rigid transparent plate 38. The rigid transparent plate 38 can be made of glass, and provides support for the transparent sheet 10.

The vessel body 8 includes a lower ring 40 that rests upon an upper surface 42 of the plate body 34. Other embodiments of resin vessel 4 and support plate 12 are possible.

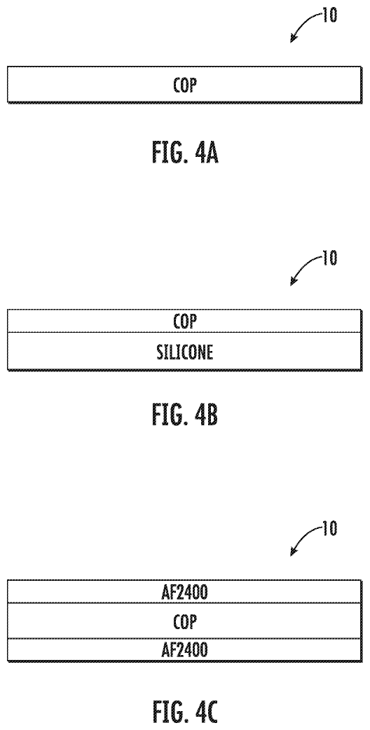

FIGS. 4A-C are cross sectional views of a portion of three different embodiments of the transparent sheet 10. The transparent sheet 10 of FIG. 4A is a single layer of COP.

The embodiments of FIGS. 4B and 4C are multilayer films. The transparent sheet 10 of FIG. 4B has a relatively thick layer of silicone and a relatively thin layer of COP. The COP can be in contact with the resin 6 due to its better material resistance to the resin 6 for some resins. The silicone may have better transmissivity for the inhibitor.

The transparent sheet 10 of FIG. 4C has layers of Teflon AF2400 on both sides of a layer of COP. This multilayer design may have advantages of material compatibility and oxygen transmission over a single layer of COP of the same thickness.

The specific embodiments and applications thereof described above are for illustrative purposes only and do not preclude modifications and variations encompassed by the scope of the following claims.

What is claimed:

1. A three-dimensional printing system for fabricating a three-dimensional article comprising:
a resin vessel for containing resin and including:
a vessel body defining a central opening; and
a transparent sheet that closes the central opening, the transparent sheet at least partially formed from a cyclic olefin polymer (COP) that is synthesized in part by applying a ring-opening metathesis polymerization (ROMP) to a monomer;
a light engine configured to project pixelated light through the transparent sheet and to a build plane within the resin;
a build tray defining a support surface for supporting the three-dimensional article to be at least partially submerged in the resin;
a motorized support configured to align and adjust a vertical position of the build tray; and
a controller for controlling the light engine and the motorized support for fabricating the three-dimensional article.

2. The three-dimensional printing system of claim 1 wherein the transparent sheet is a single layer of COP.

3. The three-dimensional printing system of claim 1 wherein the transparent sheet is a multilayer film including COP and at least one other polymer layer that is not COP.

4. The three-dimensional printing system of claim 1 wherein the monomer is norbornene.

5. The three-dimensional printing system of claim 4 wherein the norbornene is first subjected to ROMP and is then subjected to a hydrogenation.

6. The three-dimensional printing system of claim 1 further comprising a rigid transparent plate for supporting the transparent sheet.
